(19) United States
(12) Patent Application Publication
(10) Pub. No.: US 2026/0160885 A1
(43) Pub. Date: Jun. 11, 2026

(54) Systems and Methods for Determining a Condition of a Projectile in Flight

(71) Applicant: Robert T Winslow, Park City, UT (US)

(72) Inventor: Robert T Winslow, Park City, UT (US)

(21) Appl. No.: 19/414,083

(22) Filed: Dec. 9, 2025

Related U.S. Application Data
(60) Provisional application No. 63/729,797, filed on Dec. 9, 2024.

(51) Int. Cl. G01S 15/06; G01S 7/539; G01S 15/89

(52) U.S. Cl. CPC G01S 15/06; G01S 7/539; G01S 15/8977

(57) ABSTRACT

Automated systems and methods for determining a condition of a projectile in flight may automatically receive acoustic sensor signal from a single acoustic sensor physically connected to an Unmanned Aerial Vehicle. The systems and methods may automatically determine that a projectile in flight is in a tumbling condition based on the acoustic sensor signal. The systems and methods may automatically communicate a notification of the tumbling condition to a user. The systems and methods may automatically compare at least a portion of the acoustic sensor signal to stored sensor data. The systems and methods may perform the comparing in the frequency domain. The systems and methods may perform the determining based on correlating one or more characteristics of the acoustic sensor signal to one or more characteristics of the stored sensor data associated with a tumbling state.

### CROSS-REFERENCE TO RELATED APPLICATIONS

This application claims the benefit of U.S. Provisional Application No. 63/729,797, filed Dec. 9, 2024, which is hereby incorporated by reference in its entirety.

### BACKGROUND

Many projectiles may be configured for a spin-stabilized flight. Many projectiles may experience a pre-stabilized portion of flight prior to a spin-stabilized portion of flight. Many projectiles may experience an unstable portion of flight after a spin-stabilized portion of flight. Unstable portions of flight may result in many projectiles tumbling during flight.

In many applications, projectiles in flight may remain spin-stabilized through impact on target for accurate and/or consistent impacts on target. Some projectiles may remain accurate and/or consistent through a transition phase in between a spin-stabilized portion of flight and an unstable portion of flight.

Existing approaches utilized to detect a projectile in flight may require a test range. Utilization of a test range may limit variations in elevation and environmental conditions. Existing approaches utilized to detect a projectile in flight may require large and/or expensive equipment such as Doppler radar or numerous pieces of equipment. Examples of numerous pieces of equipment include, but may not be limited to, a series of radar systems, a series of cameras, and an array of sensors. Existing approaches utilized to detect a projectile in flight may require the projectile traveling through an induction coil or laser light bands. Existing approaches utilized to detect a projectile in flight may require observers being located down range.

Accordingly, given the shortcomings of existing approaches, a need exists for unconventional approaches and devices for determining a condition of a projectile in flight.

This Background is provided to introduce a brief context for the Detailed Description that follows. This Background is not intended to be an aid in determining the scope of the claimed subject matter nor be viewed as limiting the claimed subject matter to implementations that solve any or all of the shortcomings presented above.

### BRIEF DESCRIPTION OF THE SEVERAL VIEWS OF THE DRAWINGS

The accompanying drawings, which are incorporated in and constitute a part of this specification, illustrate several embodiments and, together with the description, serve to explain the disclosed principles. In the drawings:

FIG. 1 illustrates an elevation view of an example ballistic trajectory of an example projectile, consistent with disclosed embodiments.

FIG. 2 illustrates an aerial view of an example ballistic trajectory of an example projectile fired into an example crosswind, consistent with disclosed embodiments.

FIG. 3 illustrates an elevation view of an example UAV in proximity to an example projectile in flight, consistent with disclosed embodiments.

FIG. 4 is a block diagram of a first example system for determining a condition of a projectile in flight, consistent with disclosed embodiments.

FIG. 5 is a flow diagram of an example process for determining a condition of a projectile in flight, consistent with disclosed embodiments.

FIG. 6 is a flow diagram of an example process for classifying a condition of a projectile, consistent with disclosed embodiments.

FIG. 7 is a block diagram of an example UAV for determining a condition of a projectile in flight, consistent with disclosed embodiments.

FIG. 8 illustrates an elevation view of a plurality of example UAVs in proximity to an example projectile in flight, consistent with disclosed embodiments.

FIG. 9 is a block diagram of a second example system for determining a condition of a projectile in flight, consistent with disclosed embodiments.

FIG. 10 is a block diagram of an example computing environment in which aspects of disclosed embodiments may be practiced.

### DETAILED DESCRIPTION OF EMBODIMENTS

Some disclosed embodiments provide unconventional systems and methods for determining a condition of a projectile in flight. For this disclosure, determining a condition of a projectile in flight is the same as determining a condition of a projectile during a flight that just ended. Embodiments consistent with the present disclosure are necessarily rooted in computer, aeronautical, and data collecting technologies and may include collecting and processing various types of information including acoustic sensor information. Acoustic sensor information may be based on an acoustic sensor signal captured by a single acoustic sensor.

Determining a condition of a projectile in flight through utilization of disclosed embodiments may lead to improved efficiency over existing devices and technological processes since time required to setup and/or deploy the disclosed embodiments may be significantly less than existing devices and technological processes. Determining a condition of a projectile in flight through utilization of disclosed embodiments may lead to improved efficiency over existing devices and technological processes since time required to capture and/or process acoustic sensor signals and/or acoustic sensor information may be significantly less than existing devices and technological processes. Determining a condition of a projectile in flight through utilization of disclosed embodiments may cost significantly less than existing devices and technological processes. Determining a condition of a projectile in flight through utilization of disclosed embodiments may require much less ammunition than use of existing devices and technological processes.

Determining a condition of a projectile in flight through utilization of disclosed embodiments may lead to improved safety over existing approaches that include placing one or more observers down range to observe or listen for projectile conditions. In addition, a projectile in flight may become unstable far above a ground level. Furthermore, a projectile in flight may become unstable just before impacting a target. Impacts on target may cause projectiles to fragment thus endangering any observers nearby the target. Finally, considerable time may be required for observers to safely travel to and from positions down range.

Determining a condition of a projectile in flight through utilization of disclosed embodiments may lead to improved effectiveness over existing devices and technological processes since disclosed embodiments may be deployable in locations and use cases specific to a variety of users. For example, environmental impacts on a projectile in flight may vary from environmental impacts on projectiles having the same projectile data launched inside a test range. For example, projectiles launched from one projectile launching device may experience different ballistic trajectories from projectiles having the same projectile data launched from a second projectile launching device.

Some existing devices and technological processes for determining a condition of a projectile in flight may require an array of sensors. Arrays of sensors may be more expensive than a single acoustic sensor. Locating arrays of sensors for effective signal collection may be time consuming, especially when signal collection may be desired for a plurality of targets at a plurality of distances from a FFP. Arrays of sensors may be difficult or impossible to effectively deploy on a UAV.

Some existing devices and technological processes for determining a condition of a projectile in flight may require a projectile to travel through an induction coil or laser light bands. However, when testing a range of stabilized flight or an effective range of a transition phase, equipment that requires a projectile to travel through an induction coil or laser light bands may be damaged by the projectile.

Some disclosed embodiments provide unconventional systems and methods for automatically determining that a projectile in flight may be in a tumbling condition. Embodiments consistent with the present disclosure are necessarily rooted in computer technology and may include determining a tumbling condition based on an acoustic sensor signal captured from a single acoustic sensor physically connected to a UAV. Automatically determining that a projectile in flight may be in a tumbling condition utilizing the disclosed systems and methods may lead to improved efficiency over the complexity of existing devices and technological processes utilized to derive a trajectory of a projectile in flight or detect a projectile condition.

Some disclosed embodiments provide unconventional systems and methods for automatically constructing a reference table of projectile conditions. The reference table may, for example, comprise projectile conditions for a plurality of distances from a FFP. The reference table may, for example, comprise projectile conditions for a plurality of target distances and/or locations. The reference table may, for example, comprise projectile conditions for a plurality of environmental conditions. The reference table may be utilized by shooters to more efficiently estimate an effective range for a specific projectile. The reference table may be utilized by shooters to more efficiently estimate an effective range for a specific projectile in specific environmental conditions. The reference table may be utilized by shooters to more efficiently estimate an effective range for a specific projectile launched from a specific projectile launching device.

Some disclosed embodiments provide unconventional systems and methods for determining an acoustic sensing location for one or more UAVs based on one or more of the following: a ballistic trajectory of a projectile, a FFP location, and/or target information. Embodiments consistent with the present disclosure are necessarily rooted in computer technology and may include determining coordinates for each of one or more UAVs. The coordinates may be utilized by various embodiments to automatically navigate one or more UAVs to an acoustic sensing location. The one or more UAV's may be configured to capture an acoustic sensor signal at an acoustic sensing location.

As used herein, projectiles are configured to be unguided, and may be considered kinetic projectiles and/or delivery projectiles. Examples of projectiles include, but may not be not limited to, bullets, arrows, bolts, rocket assisted, and gun-launched rockets. Projectiles may be launched from projectile launching devices such as, for example, firearms, pneumatic rifles, railguns, coilguns, cannons, bows, crossbows, harpoon guns, or rocket launchers.

As used herein, a final firing position (FFP) is a position from where a projectile may be launched or fired.

As used herein, projectiles may be launched with aid of a sighting system. A sighting system may comprise a scope. A scope may comprise a reticle. A sighting system may comprise at least one adjustable component. A sighting system may comprise a sight. A sighting system may comprise a front sight and a rear sight. A front sight and/or a rear sight may comprise an adjustable component which may be configured to adjust a sighting system vertically (i.e., elevation) or horizontally (i.e., windage).

As used herein, an unmanned aerial vehicle (UAV) may comprise an unmanned helicopter. A UAV may comprise a multi-rotor drone. Each of the rotors in a multi-rotor drone may be powered by a dedicated motor. Each of the rotors in a multi-rotor drone may be governed by an electronic speed controller. A UAV may be configured for remote control. A UAV may comprise a guidance system. A guidance system may comprise one or more satellite navigation receivers. For example, a guidance system may comprise at least one of the following: a Global Positioning System (GPS) receiver, a Global Navigation Satellite System (GLONASS) receiver, a BeiDou Navigation Satellite System (BDS) receiver, a Galileo receiver, and/or any other type of global navigation satellite system (GNSS) receiver or regional navigation satellite system (RNSS) receiver. A satellite receiver may be configured to utilize phase code technology. A satellite receiver may be configured for differential correction. A guidance system may be configured to navigate a UAV autonomously or semi-autonomously. For example, a guidance system may be configured to navigate a UAV to an acoustic sensing location. Coordinates may comprise GPS coordinates or any other coordinates that represent a three-dimensional location. Coordinates may comprise any combination of the following: distances, bearings, and/or angles from a known three-dimensional location that may be utilized to calculate an acoustic sensing location.

As used herein, area under the curve (AUC) may be utilized to measure performance of a machine learning model or classifier.

As used herein, a ballistic trajectory is to be understood as an expected flight path, estimated flight path, and/or approximated flight path of a projectile. A ballistic trajectory may comprise an expected, estimated, and/or approximated parabolic flight path of a projectile. An expected, estimated, and/or approximated parabolic flight path may be expressed as a curve that may be described mathematically. Ballistic trajectories may include a maximum ordinate which is the highest point above a line of sight between a FFP and a target that the projectile is expected, estimated, and/or approximated to reach during flight. Generally, for a specific projectile at a relatively consistent muzzle velocity, the longer the flight, the higher the maximum ordinate. Ballistic trajectories may be based on any combination of the following: calculations, mathematical models, field measurements, and/or data on previous engagements (DOPE). Calculations may utilize any combination of the following: environmental conditions, environmental parameters, projectile information, firing information, target information, and/or time of flight of a projectile. The time of flight may be calculated between two known or calculated: projectile velocities, distances from a FFP, projectile drops from a line of departure, elevations above a line of sight from a FFP to a target, and/or drifts left or right of a line of sight from a FFP to a target. Mathematical models may be based on any combination of the following: environmental conditions, environmental parameters, projectile information, firing information, target information, and/or time of flight of a projectile. Mathematical models may include, for example, drag models. Mathematical models may include, for example, trajectory engines. Field measurements may be made through utilization of one or more chronographs and/or Doppler radar systems. Field measurements may be made through utilization of one or more weather sensors. Field measurements may be made through utilization of one or more sensors physically connected to a UAV.

As used herein, a drag model is a mathematical model of drag on a projectile. The drag may be caused by fluid (e.g., air and humidity) in a surrounding environment. Many drag models rely on a ballistic coefficient which comprises a number used to describe the drag on a specific projectile compared to a standard projectile. Popular drag models for bullets include the G1 drag model, the G7 drag model, bullet specific drag models, and personalized drag models. Personalized drag models may be based on a specific projectile and/or cartridge, as well as a specific projectile launching device. Persons having ordinary skill in the art will recognize that other drag models exist including, but not limited to, G2, G5, G6, G8, and GL.

As used herein, a trajectory engine may comprise one or more mathematical models of drag on a projectile. A trajectory engine may rely on a drag coefficient. The drag coefficient may be specific for a specific projectile. A trajectory engine may rely on a velocity of a projectile.

As used herein, environmental parameters may comprise measurements of at least one of the following: air temperature, humidity, barometric pressure, air density, wind speed, wind direction, and/or any other environmental measurement.

As used herein, a wind direction may be expressed by utilizing a clock system. In a clock system, clock readings may be relative to directions. In a clock system, a direction of fire may be 12:00. For example, a shooter at a FFP facing a target may be expressed as facing 12:00. For example, wind coming from the shooter's right hand side directly perpendicular to the direction the shooter may be facing may be expressed as a 3:00 wind. For example, wind coming from the shooter's left hand side directly perpendicular to the direction the shooter may be facing may be expressed as a 9:00 wind. For example, wind coming from directly behind the shooter may be expressed as a 6:00 wind.

Embodiments consistent with the present disclosure may include projectile information which may comprise projectile data related to a projectile. The projectile data may comprise at least one of the following: mass, caliber, at least one dimension, shape, sectional density, and/or ballistic coefficient.

Embodiments consistent with the present disclosure may include firing information which may comprise firing data related to a projectile launching device. The firing data may comprise at least one of the following: direction of fire, angle of departure, barrel length, barrel twist rate, sight height above bore, draw length, draw weight, IBO (International Bowhunting Organization 1) speed, expected muzzle velocity of a projectile, and/or expected projectile velocity at launch.

Embodiments consistent with the present disclosure may include target information which may comprise target data related to a target. The target data may comprise at least one of the following: a range to a target (from a FFP), a bearing to a target (from a FFP), time of flight of a projectile to reach a target, target dimensions, target material (e.g., paper, steel), target elevation, and/or inclination angle to a target (from a FFP). The range to a target may comprise a line of sight distance from a FFP to the target, or a horizontal distance (i.e., effective range) from the FFP to the target.

Embodiments consistent with the present disclosure may include a FFP location. The FFP location may be expressed as FFP coordinates. The FFP location may be a FFP point selected on a map. The FFP point selected on a map may be converted into the FFP coordinates. The FFP coordinates may comprise GPS coordinates or any other coordinates that represent a three-dimensional location.

Embodiments consistent with the present disclosure may include a target location. The target location may be expressed as target coordinates. The target location may be a target point selected on a map. The target point selected on a map may be converted into the target coordinates. The target coordinates may comprise GPS coordinates or any other coordinates that represent a three-dimensional location. The target location may be derived using a bearing from a FFP and a distance from the FFP. A target may be identified by a laser.

Embodiments consistent with the present disclosure may comprise systems and/or devices that may be configured to communicate automatically with one or more user devices. A user device may comprise a mobile computing device. A user device may comprise a wearable computing device. A user device may comprise an electronic range finder. A user device may comprise a weather meter. A weather meter may comprise at least one weather sensor. A weather meter may be integrated into a weather station. A user device may comprise a sighting system. A sighting system may be configured for automatic reticle and/or pin adjustment for elevation and/or windage. A user device may comprise a projectile velocity measurement system. At least one user device may be configured to communicate with at least one UAV. Each of a plurality of user devices may be configured to communicate with at least one other user device.

Embodiments consistent with the present disclosure may include capturing and/or processing acoustic sensor signals. An acoustic sensor may be configured to convert one or more sound waves into an electrical signal. An acoustic sensor may be utilized to measure sound pressure or acoustic pressure. An acoustic sensor may be utilized to measure an atmospheric pressure.

Embodiments consistent with the present disclosure may include an automated system. The automated system may comprise at least one memory storing instructions. The automated system may comprise at least one processor that may be configured to execute the instructions to perform operations. The operations may comprise automatically receiving an acoustic sensor signal from a single acoustic sensor. The single acoustic sensor may be physically connected to a UAV. The operations may comprise automatically determining that a projectile in flight may be in a tumbling condition. Determining that a projectile in flight may be in a tumbling condition may be based on the acoustic sensor signal from the single acoustic sensor. The operations may comprise automatically communicating a notification of the tumbling condition to a user of the system.

Embodiments consistent with the present disclosure may include a method. The method may be fully automated. The method may comprise receiving an acoustic sensor signal from a single acoustic sensor. The single acoustic sensor may be physically connected to a UAV. The UAV may be located between a FFP and a target. The method may comprise automatically determining that a projectile in flight may be in a tumbling condition. Determining that a projectile in flight may be in a tumbling condition may be based on the acoustic sensor signal from the single acoustic sensor. The method may comprise automatically communicating a notification of the tumbling condition to a user.

Embodiments consistent with the present disclosure may include a UAV. The UAV may comprise an acoustic sensor. The UAV may comprise at least one memory storing instructions. The UAV may comprise at least one processor that may be configured to execute the instructions to perform operations. The operations may comprise automatically receiving an acoustic sensor signal from the acoustic sensor. The operations may comprise automatically determining that a projectile in flight may be in a tumbling condition, the determining based on the acoustic sensor signal. The operations may comprise automatically communicating a notification of the tumbling condition to a user of the UAV.

Embodiments consistent with the present disclosure may include a plurality of UAV's. Each of the UAV's may comprise a single acoustic sensor. Systems and methods in the present disclosure may comprise receiving an acoustic sensor signal from a single acoustic sensor from each of the UAV's. Systems and methods in the present disclosure may comprise automatically determining that a projectile in flight may be in a tumbling condition. Determining that a projectile in flight may be in a tumbling condition may be based on the acoustic sensor signal from a single acoustic sensor from a single UAV independent of the other acoustic sensor signals from one or more other UAV's in the plurality of UAV's.

Embodiments consistent with the present disclosure may include automatically communicating a notification of a tumbling condition to a user. A notification may comprise a digital communication. A notification may comprise an analog communication. A notification may comprise an audible communication. A notification may comprise visible communication. A notification may comprise a presentation on a display. A notification may comprise a notification in a database.

Embodiments consistent with the present disclosure may include automatically estimating a ballistic trajectory of a projectile. A ballistic trajectory may be based on at least one of the following: projectile information, firing information, target information, and/or any other ballistic information. Embodiments consistent with the present disclosure may include electronically retrieving a ballistic trajectory of a projectile from a database in communication with a system, device, and/or UAV. A ballistic trajectory may be based on at least projectile information. Embodiments consistent with the present disclosure may include automatically determining a location for a UAV based on a ballistic trajectory. Embodiments consistent with the present disclosure may include electronically communicating a location to a guidance system of a UAV. The guidance system may be configured to cause the UAV to navigate to the location. Embodiments consistent with the present disclosure may include automatically determining a flight path for one or more UAVs based on a ballistic trajectory. The flight path may be configured to avoid one or more ballistic trajectories. The flight path may be configured to avoid one or more areas downrange of potentially tumbling projectiles. Embodiments consistent with the present disclosure may include electronically communicating the flight path to a guidance system of a UAV. The guidance system may be configured to cause the UAV to navigate along the flight path.

Embodiments consistent with the present disclosure may include electronically receiving a ballistic trajectory of a projectile or electronically retrieving the ballistic trajectory of the projectile from a database.

Embodiments consistent with the present disclosure may include automatically communicating a notification of a tumbling condition to a user. One or more UAVs may be configured to communicate the notification to one or more user devices. One or more user devices may be in communication with one or more UAVs.

In some embodiments, operations may comprise automatically communicating environmental data to a user. One or more UAVs may be configured to communicate environmental data to one or more user devices. One or more user devices may be in communication with one or more UAVs. The operations may comprise automatically assessing an environmental condition based on the environmental data, and automatically communicating the environmental condition to the user. The environmental condition may comprise a wind speed. The environmental condition may be based on environmental parameters. The environmental parameters may be based on weather sensor data received from a weather sensor. The weather sensor may be collocated with a FFP, a target, or at a location between the FFP and the target. The weather sensor data may be received before or during a flight of a UAV.

Embodiments consistent with the present disclosure may include firing location information. The firing location information may comprise a FFP location. The FFP location may comprise a three-dimensional location.

Embodiments consistent with the present disclosure may include target location information. The target location information may comprise a target location. The target location may comprise a three-dimensional location. The target location may comprise a two-dimensional location at ground level. The target location may be determined through utilization of firing information and/or target information.

Embodiments consistent with the present disclosure may include automatically collecting environmental data. Collecting environmental data may comprise receiving environmental sensor data from at least one UAV environmental sensor.

Embodiments consistent with the present disclosure may include automatically communicating environmental data to a user. One or more UAVs may be configured to communicate environmental data to one or more user devices. One or more user devices may be in communication with one or more UAVs. For example, a plurality of projectiles having the same projectile data may be launched from the same projectile launching device at the same FFP. At least one first of the projectiles may be determined to be in a tumbling condition. The at least one first of the projectiles may not impact a desired target. At least one second of the projectiles may be determined to be in a spin-stabilized condition. At least one second of the projectiles may impact the desired target. In this example, a UAV may be configured to capture environmental data during the flights of the projectiles. The UAV may be configured to recognize and/or report distinctions in the environmental data for the at least one first of the projectiles and the at least one second of the projectiles.

Embodiments consistent with the present disclosure may include receiving at least one of the following: projectile information, firing information, target information, and/or any other ballistic information.

Embodiments consistent with the present disclosure may include a projectile being structured to be spin stabilized in flight. Spin-stabilized projectiles may be referred to as rotationally-stabilized projectiles.

In some embodiments, a single acoustic sensor may comprise a microphone. A single acoustic sensor may comprise a condenser microphone. A single acoustic sensor may comprise a microelectromechanical system (MEMS). A single acoustic sensor may comprise a piezoelectric MEMS microphone.

Embodiments consistent with the present disclosure may include signal processing of acoustic sensor signals and/or previous acoustic sensor signals. The signal processing may comprise utilization of one or more filters to process acoustic sensor signals. The one or more filters may comprise a filter bank of bandpass filters. The one or more filters may comprise a cascade of second order filters. The signal processing may comprise utilization of compression and rectification. The signal processing may comprise utilization of automatic gain control (AGC). Use of AGC may include a cascade of AGCs. Each AGC in a cascade of AGCs may be configured with a distinct adaptation time constant. The signal processing may comprise utilization of spike generation. Utilization of spike generation may include a plurality of spike generators. Each of the spike generators may be configured for a distinct voltage threshold. The signal processing may comprise periodicity feature extraction. Signal processing of acoustic sensor signals and/or previous acoustic sensor signals may result in acoustic sensor information and/or previous acoustic sensor information. The acoustic sensor information and/or previous acoustic sensor information may comprise spectral components and/or temporal components.

Some embodiments may include automatically comparing at least a portion of an acoustic sensor signal to stored sensor data. The stored sensor data may comprise one or more previous acoustic sensor signals. The previous acoustic sensor signals may have been captured from the same sensor as the acoustic sensor signal. The stored sensor data may be classified. Some embodiments may include automatically transforming at least a portion of an acoustic sensor signal to a frequency domain. For example, a fast Fourier transform (FFT) may be utilized in the transforming. Comparing at least a portion of an acoustic sensor signal to stored sensor data may be performed in the frequency domain. For example, at least one frequency component of an acoustic sensor signal may be compared to at least one frequency component of stored sensor data. Comparing at least a portion of an acoustic sensor signal to stored sensor data may be performed in a time domain.

In some embodiments, automatically determining that a projectile in flight may be in a tumbling condition may be based on correlating one or more characteristics of an acoustic sensor signal captured by an acoustic sensor to one or more characteristics of stored sensor data. The stored sensor data may comprise one or more acoustic sensor signals previously captured by the same acoustic sensor for previous projectiles in flight. One or more characteristics of the stored sensor data may be associated with a tumbling state. At least a portion of the stored sensor data may be associated with a tumbling state. At least a portion of the stored sensor data may have been previously classified as being associated with a tumbling state. A first portion of the stored sensor data may be associated with a spin-stabilized state. A second portion of the stored sensor data may be associated with a tumbling state. A tumbling state may be determined from a tumbling condition of previous projectiles having the same projectile data as the projectile in flight.

Some embodiments may include automatically comparing at least a portion of an acoustic sensor signal to stored acoustic data. The stored acoustic data may comprise one or more previous acoustic sensor signals. The previous acoustic sensor signals may have been captured utilizing at least one other single acoustic sensor than the single acoustic sensor utilized to capture the acoustic sensor signal. The stored acoustic data may be classified. Some embodiments may include automatically transforming at least a portion of an acoustic sensor signal to a frequency domain. For example, a fast Fourier transform (FFT) may be utilized in the transforming. Comparing at least a portion of an acoustic sensor signal to stored acoustic data may be performed in the frequency domain. For example, at least one frequency component of an acoustic sensor signal may be compared to at least one frequency component of stored acoustic data. Comparing at least a portion of an acoustic sensor signal to stored acoustic data may be performed in a time domain.

In some embodiments, automatically determining that a projectile in flight may be in a tumbling condition may be based on correlating one or more characteristics of an acoustic sensor signal captured by a first acoustic sensor to one or more characteristics of stored acoustic data. The stored acoustic data may comprise one or more acoustic sensor signals previously captured by at least one second acoustic sensor for previous projectiles in flight. One or more characteristics of the stored acoustic data may be associated with a tumbling state. At least a portion of the stored acoustic data may be associated with a tumbling state. At least a portion of the stored acoustic data may have been previously classified as being associated with a tumbling state. A first portion of the stored acoustic data may be associated with a spin-stabilized state. A second portion of the stored acoustic data may be associated with a tumbling state. The tumbling state may be determined from a tumbling condition of previous projectiles having the same projectile data as the projectile in flight.

In some embodiments, a ballistic trajectory may be based on environmental parameters. The environmental parameters may be based on weather sensor data received from a weather sensor. The weather sensor may be collocated with a FFP, a target, or at a location between the FFP and the target. The weather sensor data may be received before or during the flight of a UAV.

In some embodiments, environmental data may comprise wind speed data and/or wind direction data. The environmental data may comprise air temperature data. The environmental data may comprise barometric pressure data. The environmental data may comprise humidity data. The environmental data may comprise air density data.

In some embodiments, automatically determining that a projectile in flight may be in a tumbling condition may be based on automatically classifying a condition of a projectile in flight based on an acoustic sensor signal. A classifier (e.g., 422, 722, 922) may be configured to automatically classify a condition of a projectile in flight based on a correlation between at least a portion of an acoustic sensor signal and at least a portion of one or more previous acoustic sensor signals. The correlation between at least a portion of an acoustic sensor signal and at least a portion of one or more previous acoustic sensor signals may be performed in a frequency domain. Stored sensor data (e.g., 432, 732, 932) and/or stored acoustic data (e.g., 434, 734, 934) may comprise the at least a portion of one or more previous acoustic sensor signals. At least a portion of stored sensor data may be classified as spin-stabilized data. At least a portion of stored sensor data may be classified as tumbling data. At least a portion of stored acoustic data may be classified as spin-stabilized data. At least a portion of stored acoustic data may be classified as tumbling data. A classifier may utilize one or more trained machine learning models to automatically classify a condition of a projectile.

In some embodiments, automatically determining that a projectile in flight may be in a tumbling condition may be based on automatically classifying a condition of a projectile in flight based on acoustic sensor information. A classifier (e.g., 422, 722, 922) may be configured to automatically classify a condition of a projectile in flight based on a correlation between acoustic sensor information and at least a portion of previous acoustic sensor information. The correlation between acoustic sensor information and at least a portion of previous acoustic sensor information may be performed in a frequency domain. Stored sensor data (e.g., 432, 732, 932) and/or stored acoustic data (e.g., 434, 734, 934) may comprise the at least a portion of previous acoustic sensor information. At least a portion of stored sensor data may be classified as spin-stabilized data. At least a portion of stored sensor data may be classified as tumbling data. At least a portion of stored acoustic data may be classified as spin-stabilized data. At least a portion of stored acoustic data may be classified as tumbling data. A classifier may utilize one or more trained machine learning models to automatically classify a condition of a projectile.

Some embodiments may include one or more data models. A data model may be configured to organize any combination of the following: acoustic sensor information, stored sensor data, stored acoustic data, aspects of acoustic sensor information, aspects of stored sensor data, aspects of stored acoustic data, characteristics of acoustic sensor information, characteristics of stored sensor data, and/or characteristics of stored acoustic data. A data model may comprise one or more labels. For example, a label may be associated with a spin-stabilized condition or a tumbling condition. A label may be based on input from a user. A label may be generated automatically. A label may be utilized to correlate aspects and/or characteristics of acoustic sensor information with stored sensor data and/or stored acoustic data. A label may be utilized to correlate aspects and/or characteristics of acoustic sensor information with aspects and/or characteristics of stored sensor data and/or aspects and/or characteristics of stored acoustic data. A data model may be expanded. Expansion of a data model may be based on newly labeled samples. Newly labeled samples may be labeled based on acoustic sensor information, stored sensor data, and/or stored acoustic data, originating from one or more single acoustic sensors. Labeled samples may comprise an additional class of data.

Some embodiments may include one or more machine learning models. One or more trained machine learning models may be utilized to automatically classify a condition of a projectile. For example, a machine learning model may comprise a support vector machine (SVM). For example, a machine learning model may comprise a random forest. For example, a machine learning model may comprise linear discriminant analysis (LDA). For example, a machine learning model may comprise one or more linear mixed-effects (LME) models. A machine learning model may be trained through utilization of one or more training data sets to generate a trained machine learning model. A training data set may comprise candidate spikes. Candidate spikes may be identified through utilization of constant thresholding. A training data set may comprise aspects and/or characteristics of acoustic sensor information. For example, a training data set may comprise acoustic sensor information from one or more single acoustic sensors of projectiles known to be in a spin-stabilized condition. For example, a training data set may comprise acoustic sensor information from one or more single acoustic sensors of projectiles known to be in a tumbling condition. Acoustic sensor information may be automatically processed with a specific time window interval and step size. For example, the time window interval may be on the order of milliseconds. For example, the step size may be on the order of microseconds. Results of a plurality of machine learning models may be combined through utilization of ensemble learning. An output of ensemble learning may comprise labels with majority votes. A counting technique may be utilized to improve AUC.

Some embodiments may include one or more deep learning models. One or more deep learning models may be utilized to improve classification performance of one or more machine learning models. One or more deep learning models may be utilized to automatically identify higher-level characteristics of acoustic sensor signals, acoustic sensor information, stored sensor data, and/or stored acoustic data. A two-dimensional input may be constructed through utilization of past window data. A convolutional neural network (CNN) may be utilized on a two-dimensional input. A CNN may comprise a multilayer CNN. A multilayer CNN may comprise three or more layers. A gradient-weighted class activation mapping (Grad-CAM) framework may be utilized for interpretability of one or more classification decisions.

In some embodiments, classified data may be utilized to correlate aspects and/or characteristics of acoustic sensor information with stored sensor data and/or stored acoustic data. At least a portion of stored sensor data may be classified as being associated with a tumbling condition of a projectile in flight. At least a portion of stored sensor data may be classified as being associated with a spin-stabilized condition of a projectile in flight. At least a portion of stored acoustic data may be classified as being associated with a tumbling condition of a projectile in flight. At least a portion of stored acoustic data may be classified as being associated with a spin-stabilized condition of a projectile in flight. Classified data may be shared with one or more systems or devices. Classified data may be available to one or more systems or devices. Classified data may be based on data signals from one or more systems or devices. Classified data may be stored in cloud-based databases, system-based databases (e.g., 460, 760) and/or device-based databases (e.g., 430, 930). Classified data may be compared to data index libraries previously acquired.

Some embodiments include a classifier (e.g., 422, 722, 922). A classifier may be configured to automatically utilize classified data to determine a condition of a projectile in flight. A classifier may comprise instructions that, when executed by one or more processors, perform operations comprising automatically utilizing classified data to determine a condition of a projectile in flight. The condition of a projectile in flight may comprise a spin-stabilized condition. The condition of a projectile in flight may comprise a tumbling condition.

In some embodiments, operations may comprise automatically constructing a reference table of projectile conditions. The reference table may comprise a projectile condition at various distances from a FFP. The reference table may be based on a plurality of flights for a plurality of projectiles having the same projectile data. The reference table may comprise a target distance for each of the various distances from the FFP. The reference table may comprise one or more acoustic sensing locations where an acoustic sensor signal was captured. Each of the acoustic sensing locations may be represented by one or more of the following: coordinates, distance from a FFP, distance from a target, and/or a distance from an estimated ballistic trajectory. The distance from an estimated ballistic trajectory may be one-dimensional, two-dimensional, and/or three-dimensional. The reference table may comprise one or more elevations where an acoustic sensor signal was captured. The operations may comprise automatically adding additional entries to the reference table over additional times and/or dates. The operations may comprise automatically constructing additional reference tables for any combination of additional: projectiles, distances from a FFP, target distances, environmental conditions, locations, and/or elevations. Example reference tables of projectile conditions are included below.

TABLE 1
First Example Reference Table

| | | UAV | UAV | Projectile |
|---|---|---|---|---|
| Date | Time | Location | Elevation | Condition |
| Dec. 10, 2024 | 8:39 AM | 1780 yd. | 5005′ | spin stabilized |
| | | from FFP | | |
| Dec. 10, 2024 | 8:40 AM | 1790 yd. | 5004′ | spin stabilized |
| | | from FFP | | |
| Dec. 10, 2024 | 8:41 AM | 1800 yd. | 5006′ | spin stabilized |
| | | from FFP | | |
| Dec. 10, 2024 | 8:42 AM | 1810 yd. | 5005′ | spin stabilized |
| | | from FFP | | |
| Dec. 10, 2024 | 8:43 AM | 1820 yd. | 5007′ | spin stabilized |
| | | from FFP | | |
| Dec. 10, 2024 | 8:44 AM | 1830 yd. | 5003′ | spin stabilized |
| | | from FFP | | |
| Dec. 10, 2024 | 8:45 AM | 1840 yd. | 5009′ | spin stabilized |
| | | from FFP | | |
| Dec. 10, 2024 | 8:46 AM | 1850 yd. | 5015′ | tumbling |
| | | from FFP | | |
| Dec. 10, 2024 | 8:47 AM | 1860 yd. | 5025′ | tumbling |
| | | from FFP | | |

TABLE 2
Second Example Reference Table

| | | UAV | Target | UAV | UAV | Projectile |
|---|---|---|---|---|---|---|
| Date | Time | Distance | Distance | Elevation | Wind | Condition |
| Dec. 10, 2024 | 9:39 AM | 1850 yd. | 1870 yd. | 5015′ | 3 mph, 1:00 | tumbling |
| Dec. 10, 2024 | 9:40 AM | 1850 yd. | 1870 yd. | 5015′ | 3 mph, 1:00 | tumbling |
| Dec. 10, 2024 | 9:41 AM | 1850 yd. | 1870 yd. | 5015′ | 4 mph, 5:00 | spin stabilized |
| Dec. 10, 2024 | 9:42 AM | 1850 yd. | 1870 yd. | 5015′ | 5 mph, 5:00 | spin stabilized |
| Dec. 10, 2024 | 9:43 AM | 1850 yd. | 1870 yd. | 5015′ | 4 mph, 1:00 | tumbling |
| Dec. 10, 2024 | 9:44 AM | 1850 yd. | 1870 yd. | 5015′ | 5 mph, 1:00 | tumbling |
| Dec. 10, 2024 | 9:45 AM | 1850 yd. | 1870 yd. | 5015′ | 6 mph, 5:00 | spin stabilized |
| Dec. 10, 2024 | 9:46 AM | 1850 yd. | 1870 yd. | 5015′ | 7 mph, 5:00 | spin stabilized |
| Dec. 10, 2024 | 9:47 AM | 1850 yd. | 1870 yd. | 5015′ | 6 mph, 1:00 | tumbling |

TABLE 3
Third Example Reference Table

| | | UAV | Target | UAV | UAV | Projectile |
|---|---|---|---|---|---|---|
| Date | Time | Distance | Distance | Elevation | Temp (F.) | Condition |
| Dec. 10, 2024 | 10:39 AM | 1850 yd. | 1870 yd. | 5015′ | 85 | tumbling |
| Dec. 10, 2024 | 10:49 AM | 1850 yd. | 1870 yd. | 5015′ | 85 | tumbling |
| Dec. 10, 2024 | 10:59 AM | 1850 yd. | 1870 yd. | 5015′ | 86 | tumbling |
| Dec. 10, 2024 | 11:09 AM | 1850 yd. | 1870 yd. | 5015′ | 87 | tumbling |
| Dec. 10, 2024 | 11:19 AM | 1850 yd. | 1870 yd. | 5015′ | 88 | tumbling |
| Dec. 10, 2024 | 11:29 AM | 1850 yd. | 1870 yd. | 5015′ | 89 | tumbling |
| Dec. 10, 2024 | 11:39 AM | 1850 yd. | 1870 yd. | 5015′ | 92 | spin stabilized |
| Dec. 10, 2024 | 11:49 AM | 1850 yd. | 1870 yd. | 5015′ | 95 | spin stabilized |
| Dec. 10, 2024 | 11:59 AM | 1850 yd. | 1870 yd. | 5015′ | 99 | spin stabilized |

Some embodiments may utilize a first wireless network for communicating between one or more systems and/or devices and one or more UAV's. A plurality of UAV's may be configured to communicate to one or more other UAV's through utilization of the first wireless network or a second wireless network.

Reference will now be made in detail to example embodiments, examples of which are illustrated in the accompanying drawings and disclosed herein. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

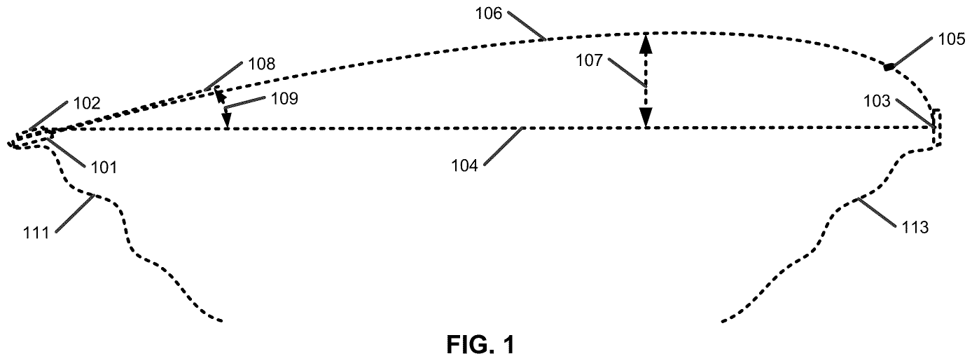

FIG. 1 illustrates an elevation view of an example ballistic trajectory 106 of an example projectile 105, consistent with disclosed embodiments. Projectile 105 may be launched from launching device 101. Sighting system 102 may be associated with launching device 101. Launching device 101 and sighting system 102 may be located at a FFP. The FFP may be located on FFP terrain 111. Target 103 may be located on target terrain 113. Line of sight 104 may comprise a line of sight from sighting system 102 to target 103. Launching device 101 may be adjusted to a line of departure 108. Angle of departure 109 may comprise the angle between line of sight 104 and line of departure 108. Angle of departure 109 may be necessary in order for projectile 105 to hit target 103 given ballistic trajectory 106. Ballistic trajectory 106 may comprise a maximum ordinate. Maximum ordinate height 107 may comprise an estimated height above line of sight 104 at the maximum ordinate.

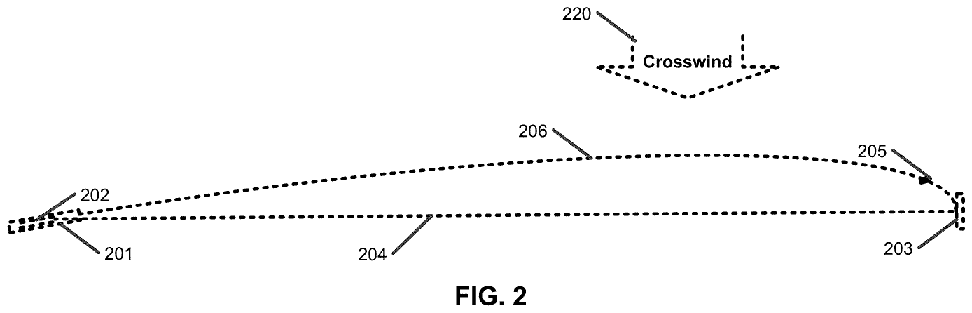

FIG. 2 illustrates an aerial view of an example ballistic trajectory 206 of an example projectile 205 fired into an example crosswind 220 (as shown), consistent with disclosed embodiments. Projectile 205 may be launched from launching device 201. Sighting system 202 may be associated with launching device 201. Line of sight 204 may comprise a line of sight from sighting system 202 to target 203.

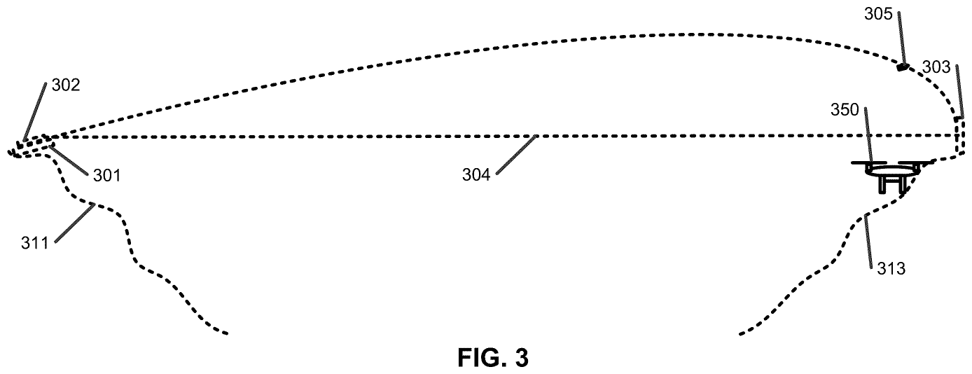

FIG. 3 illustrates an elevation view of an example UAV 350 in proximity to an example projectile 305 in flight, consistent with disclosed embodiments. Projectile 305 may be launched from launching device 301. Sighting system 302 may be associated with launching device 301. Launching device 301 and sighting system 302 may be located at a FFP. The FFP may be located on FFP terrain 311. Target 303 may be located on target terrain 313. Line of sight 304 may comprise a line of sight from sighting system 302 to target 303.

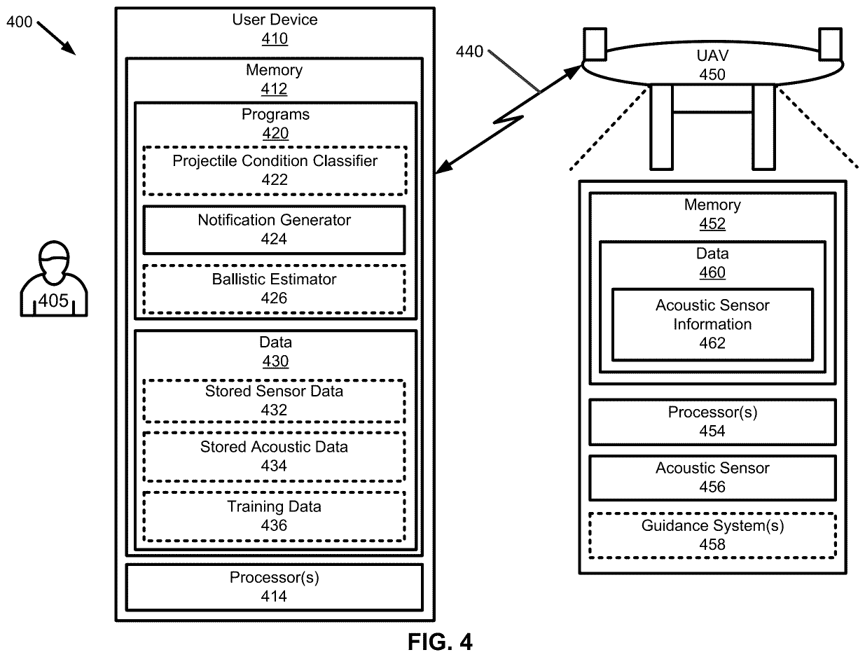

FIG. 4 is a block diagram of a first example system 400 for determining a condition of a projectile in flight, consistent with disclosed embodiments. System 400 may comprise UAV 450 and user device 410. UAV 450 may comprise at least one memory 452, one or more processors 454, and a single acoustic sensor 456. UAV 450 may comprise one or more guidance systems 458. Memory 452 may be configured to store data 460. Data 460 may comprise acoustic sensor information 462. UAV 450 may be configured to communicate with user device 410 over wireless network 440. User device 410 may comprise at least one memory 412, and one or more processors 414. Memory 412 may comprise programs 420 and data 430. Programs 420 may comprise projectile condition classifier 422. Projectile condition classifier 422 may be configured to automatically classify a condition of a projectile in flight based on a correlation between acoustic sensor information 462 and at least a portion of previous acoustic sensor information. Programs 420 may comprise notification generator 424. Notification generator 424 may be configured to automatically communicate a notification of a projectile condition to user 405. Programs 420 may comprise ballistic estimator 426. Ballistic estimator 426 may be configured to estimate a ballistic trajectory of at least one projectile. The ballistic trajectory may be based on at least: projectile information, firing information, and target information. A ballistic trajectory may be utilized to automatically determine an acoustic sensing location for UAV 450. Data 430 may comprise stored sensor data 432 and/or stored acoustic data 434. Data 430 may comprise training data 436. User device 410 may be configured to be operable by user 405.

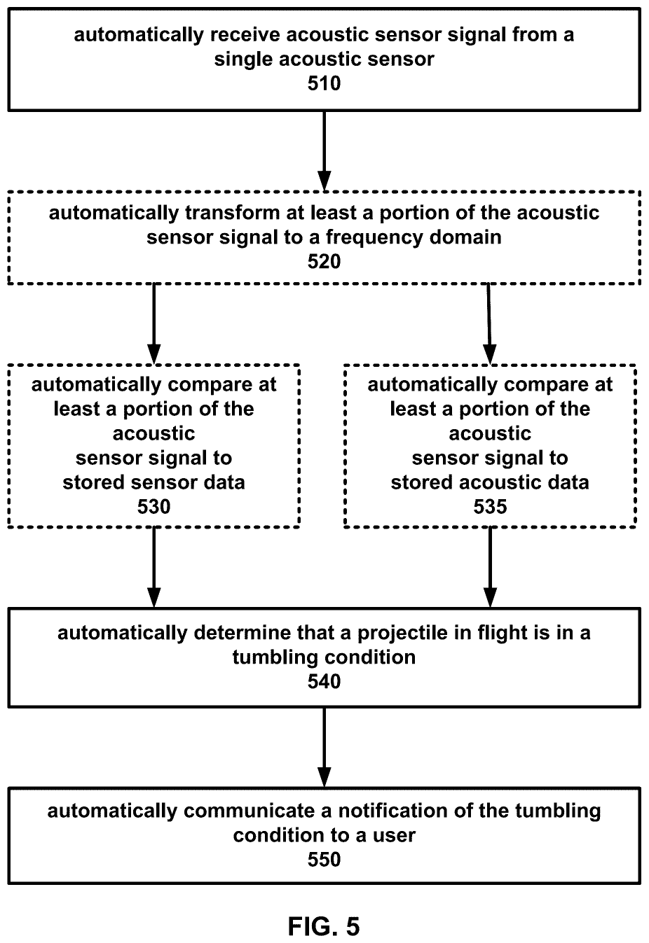

FIG. 5 is a flow diagram of an example process for determining a condition of a [0081] projectile in flight, consistent with disclosed embodiments. An acoustic sensor signal may be automatically received from a single acoustic sensor at 510. At least a portion of the acoustic sensor signal may be automatically transformed to a frequency domain at 520. At least a portion of the acoustic sensor signal may be automatically compared to stored sensor data at 530. At least a portion of the acoustic sensor signal may be automatically compared to stored acoustic data at 535. A projectile in flight may be automatically determined to be in a tumbling condition at 540. A notification of the tumbling condition may be automatically communicated to a user at 550.

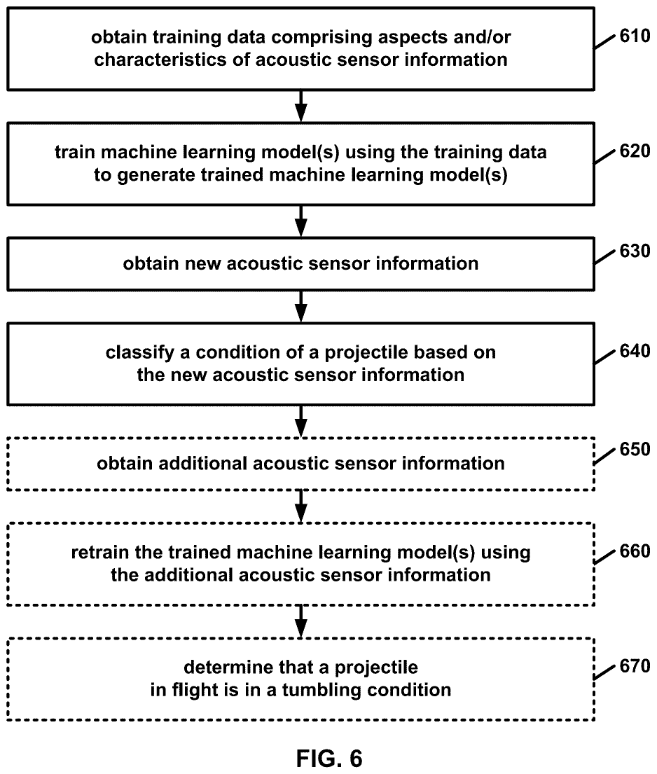

FIG. 6 is a flow diagram of an example process for classifying a condition of a projectile, consistent with disclosed embodiments. Training data may be obtained at 610. The training data may comprise aspects and/or characteristics of acoustic sensor information. The aspects and/or characteristics of acoustic sensor information may be associated with a spin-stabilized condition or a tumbling condition. One or more machine learning models may be trained using the training data to generate one or more trained machine learning models at 620. New acoustic sensor information may be obtained at 630. A condition of a projectile in flight may be classified at 640. The condition of a projectile in flight may be classified based on the new acoustic sensor information. The condition of a projectile in flight may be classified utilizing on one or more trained machine learning models. Additional acoustic sensor information may be obtained at 650. The trained machine learning model(s) may be retrained using the additional acoustic sensor information at 660. A projectile in flight may be determined to be in a tumbling condition at 670.

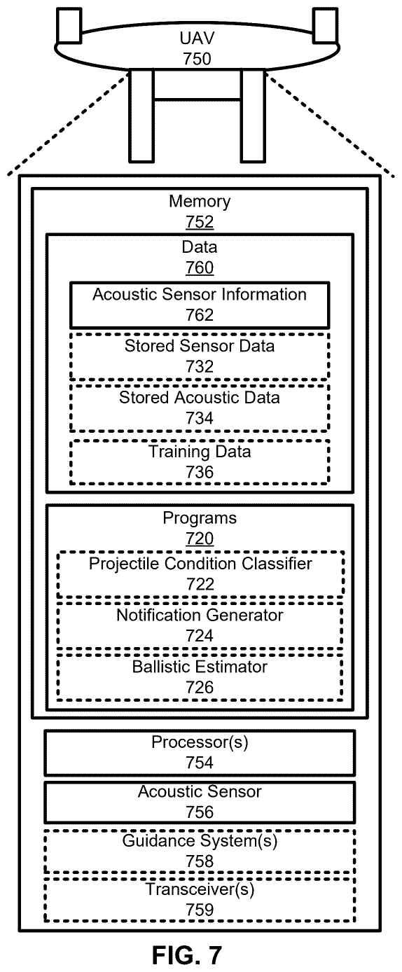

FIG. 7 is a block diagram of an example UAV 750 for determining a condition of a projectile in flight, consistent with disclosed embodiments. UAV 750 may comprise at least one memory 752, one or more processors 754, and a single acoustic sensor 756. UAV 750 may comprise one or more guidance systems 758. One or more guidance systems 758 may be utilized to navigate UAV 750 to an acoustic sensing location. UAV 750 may comprise one or more transceivers 759. One or more transceivers 759 may be configured to communicate with one or more user devices (e.g., 410, 910). Memory 752 may be configured to store data 760. Data 760 may comprise acoustic sensor information 762. Data 760 may comprise stored sensor data 732 and/or stored acoustic data 734. Data 760 may comprise training data 736. Memory 752 may comprise programs 720. Programs 720 may comprise projectile condition classifier 722. Programs 720 may comprise notification generator 724. Programs 720 may comprise ballistic estimator 726.

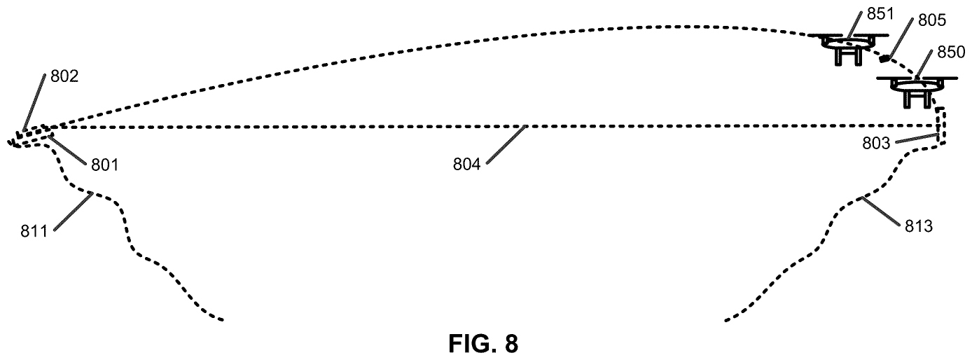

FIG. 8 illustrates an elevation view of a plurality of example UAVs (850, 851) in proximity to an example projectile 805 in flight, consistent with disclosed embodiments. Projectile 805 may be launched from launching device 801. Sighting system 802 may be associated with launching device 801. Launching device 801 and sighting system 802 may be located at a FFP. The FFP may be located on FFP terrain 811. Target 803 may be located on target terrain 813. Line of sight 804 may comprise a line of sight from sighting system 802 to target 803.

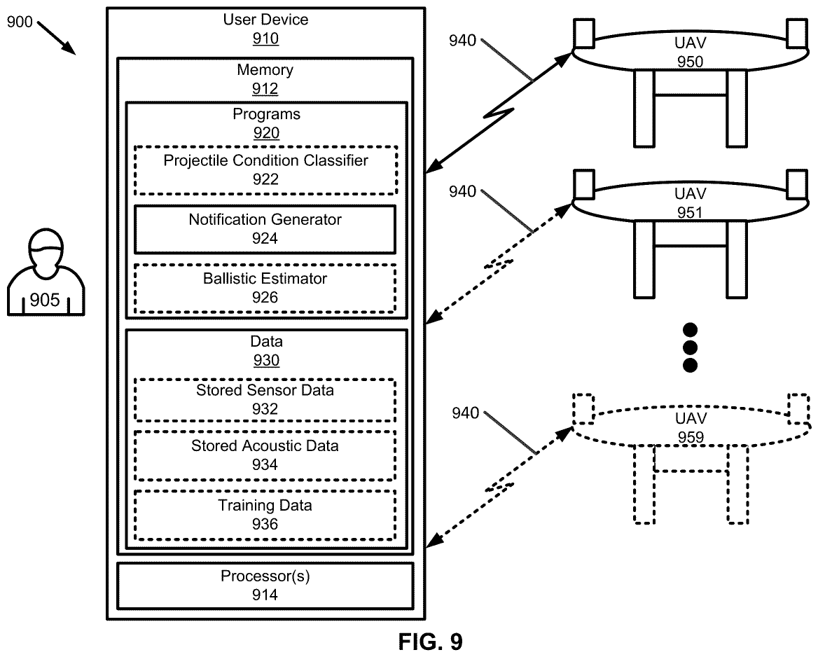

FIG. 9 is a block diagram of a second example system 900 for determining a condition of a projectile in flight, consistent with disclosed embodiments. System 900 may comprise two or more UAVs (950, 951, . . . , 959). Each of the UAV's may comprise a memory, one or more processors, and a single acoustic sensor. Each of the UAV's may comprise one or more guidance systems. The UAV's may be configured to store UAV data. UAV data may comprise acoustic sensor information. The UAV's may be configured to communicate with user device 910 over wireless network 940. For example, each of the UAV's may be configured to communicate with user device 910 directly (as shown). In another example, a first of the UAV's (e.g., 950) may be configured to communicate with user device 910 directly. The remaining one or more UAV's may be configured to communicate with the first of the UAV's. System 900 may comprise user device 910. User device 910 may comprise at least one memory 912 and one or more processors 914. Memory 912 may comprise programs 920 and data 930. Programs 920 may comprise projectile condition classifier 922. Projectile condition classifier 922 may be configured to automatically classify a condition of a projectile in flight based on a correlation between acoustic sensor information from any one of the UAV's and at least a portion of previous acoustic sensor information. Programs 920 may comprise notification generator 924. Notification generator 924 may be configured to automatically communicate a notification of a projectile condition to user 905. Programs 920 may comprise ballistic estimator 926. Ballistic estimator 926 may be configured to estimate a ballistic trajectory of at least one projectile. The ballistic trajectory may be based on at least: projectile information, firing information, and target information. A ballistic trajectory may be utilized to automatically determine an acoustic sensing location for each of the UAV's. Data 930 may comprise stored sensor data 932 and/or stored acoustic data 934. Data 930 may comprise training data 936. User device 910 may be configured to be operable by user 905.

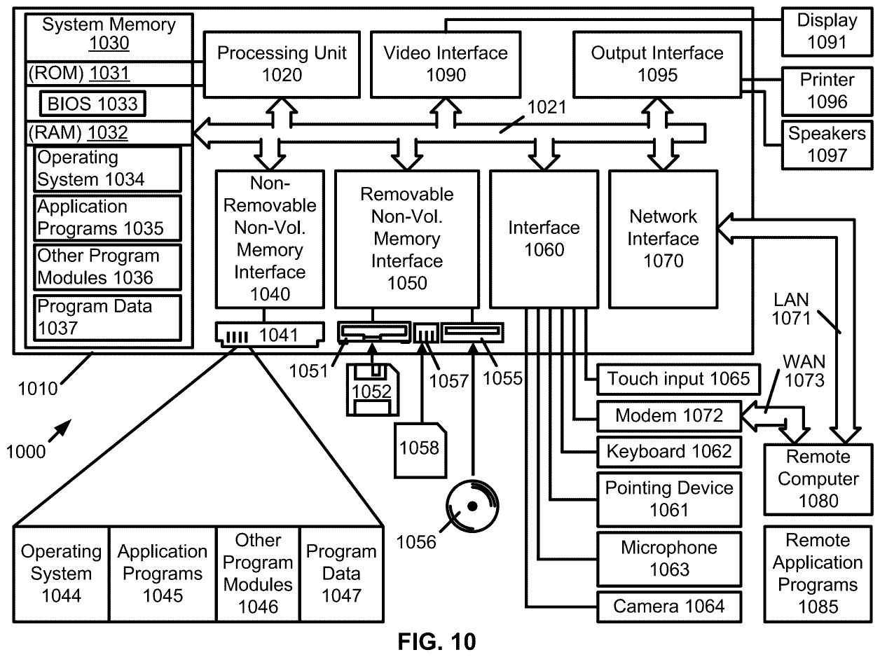

FIG. 10 is a block diagram of an example computing environment 1000 in which aspects of disclosed embodiments may be practiced. The computing environment may comprise computing device 1010. Components of computing device 1010 may include, but may not be not limited to, a processing unit 1020, a system memory 1030, and a system bus 1021 that couples various system components including the system memory 1030 to the processing unit 1020.

Computing device 1010 may comprise a variety of computer readable media. Computer readable media may be available media accessible by computing device 1010 and may include both volatile and nonvolatile media, removable and non-removable media. By way of example, and not limitation, computer readable media may comprise computer storage media and communication media. Computer storage media may comprise both volatile and nonvolatile and/or removable and non-removable media implemented in a method or technology for storage of data such as computer readable instructions, data structures, program modules, other data, and/or the any other type of method or technology for storage of data. Computer storage media may comprise, but may not be limited to, random access memory (RAM), read-only memory (ROM), electrically erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, and/or any other medium which may be utilized to store data and which may be accessed by computer 1010. Communication media may comprise computer readable instructions, data structures, program modules and/or other data in a modulated data signal such as a carrier wave and/or other transport mechanism and may comprise data delivery media. The term “modulated data signal” means a signal that has one or more of its characteristics set or changed in such a manner as to encode data in the signal. By way of example, and not limitation, communication media includes wired media such as a wired network or direct-wired connection, and wireless media such as acoustic, radio frequency (RF), infrared and other wireless media. Combinations of any of the above may also be included within the scope of computer readable media.

The system memory 1030 may comprise computer storage media in the form of volatile and/or nonvolatile memory such as ROM 1031 and RAM 1032. A basic input/output system 1033 (BIOS), containing the basic routines that help to transfer data between elements within computer 1010, such as during start-up, may be stored in ROM 1031. RAM 1032 may comprise data and/or program modules that may be accessible to and/or presently being operated on by processing unit 1020. By way of example, and not limitation, FIG. 10 illustrates operating system 1034, application programs 1035, other program modules 1036, and program data 1037.

The computing device 1010 may also comprise other removable/non-removable volatile/nonvolatile computer storage media. By way of example only, FIG. 10 illustrates a hard disk drive 1041 that may read from or write to non-removable, nonvolatile magnetic media, a magnetic disk drive 1051 that may read from or write to a removable, nonvolatile magnetic disk 1052, a flash drive reader 1057 that may read flash drive 1058, and an optical disk drive 1055 that may read from or write to a removable, nonvolatile optical disk 1056 such as a CD ROM or other optical media. Other removable/non-removable, volatile/nonvolatile computer storage media that may be used in the operating environment include, but may not be limited to, magnetic tape cassettes, flash memory cards, digital versatile disks, digital video tape, solid state RAM, and solid state ROM. The hard disk drive 1041 may be connected to the system bus 1021 through a non-removable memory interface such as interface 1040, and magnetic disk drive 1051 and optical disk drive 1055 may be connected to the system bus 1021 by a removable memory interface, such as interface 1050.

The drives and their associated computer storage media discussed above and illustrated in FIG. 10 provide storage of computer readable instructions, data structures, program modules and other data for the computer 1010. In FIG. 10, for example, hard disk drive 1041 is illustrated as storing operating system 1044, application programs 1045, program data 1047, and other program modules 1046. Additionally, for example, non-volatile memory may include instructions for presenting images on a display 1091 of computing device 1000. Similarly, non-volatile memory may comprise instructions for causing the presentation of images on the display of a remote computing device 1080. Display 1091 and touch input 1065 may be integrated into the same device.

A user may enter commands and data into computing device 1010 through input devices such as a touch input device 1065, a keyboard 1062, a microphone 1063, a camera 1064, and a pointing device 1061, such as a mouse, trackball or touch pad. These and other input devices may be connected to the processing unit 1020 through interface 1060 coupled to system bus 1021, but may be connected by other interface and bus structures, such as a parallel port, game port or a universal serial bus (USB). A display 1091 or other type of display device may be connected to the system bus 1021 via an interface, such as a video interface 1090. Other devices, such as, for example, speakers 1097 and printer 1096 may be connected to the system via output interface 1095.

The computing device 1010 may be operated in a networked environment using logical connections to one or more remote computers, such as a remote computer 1080. Remote computer 1080 may be a personal computer, a hand-held device, a server, a router, a network PC, a peer device or other common network node, and typically includes many or all of the elements described above relative to the computing device 1010. The logical connections depicted in FIG. 10 include a local area network (LAN) 1071 and a wide area network (WAN) 1073, but may also include other networks. Such networking environments may be commonplace in offices, enterprise-wide computer networks, intranets and the Internet.

When used in a LAN networking environment, the computing device 1010 may be connected to the LAN 1071 through a network interface or adapter 1070. When used in a WAN networking environment, the computing device 1010 may comprise a modem 1072 or other means for establishing communications over the WAN 1073, such as the Internet. The modem 1072, which may be internal or external, may be connected to the system bus 1021 via interface 1060, or other appropriate mechanism. The modem 1072 may be wired or wireless. Examples of wireless devices may comprise, but may not be not limited to: Wi-Fi and Bluetooth. In a networked environment, program modules depicted relative to the computing device 1010, or portions thereof, may be stored in the remote memory storage device. By way of example, and not limitation, FIG. 10 illustrates remote application programs 1085 as residing on remote computer 1080. It will be appreciated that the network connections shown may not be presented as examples only and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In this specification, “a” and “an” and similar phrases are to be interpreted as “at least one” and “one or more.” References to “a”, “an”, and “one” are not to be interpreted as “only one”. In this specification, the term “may” is to be interpreted as “may, for example.” In other words, the term “may” is indicative that the phrase following the term “may” is an example of one of a multitude of suitable possibilities that may, or may not, be utilized to one or more of the various embodiments. In this specification, the phrase “based on” is indicative that the phrase following the term “based on” is an example of one of a multitude of suitable possibilities that may, or may not, be utilized to one or more of the various embodiments. References to “an” embodiment in this disclosure are not necessarily to the same embodiment. Any embodiment described above as an “example” is not to be construed as necessarily preferred or advantageous over other embodiments.

The terms “first,” “second,” etc., as used in this specification, are used as labels for nouns that they precede, and do not imply any type of ordering (e.g., spatial, temporal, logical, etc.) unless explicitly defined as such. Furthermore, the same or similar reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used in the figures and in this specification have the same meaning as commonly understood by a person having ordinary skill in the art(s) to which this subject matter belongs. It should be further understood that terms should be interpreted as having a meaning that is consistent with their meaning in the context of the relevant art(s) and should not be interpreted in an idealized or overly formal sense unless expressly so defined herein.

Many of the elements described in the disclosed embodiments maybe implemented as operations. An operation is defined here as an isolatable element that performs a defined function and has a defined interface to other elements. The operations described in this disclosure may be implemented in hardware, a combination of hardware and software, firmware, wetware (in other words, hardware with a biological element), or a combination thereof, all of which are behaviorally equivalent. For example, operations may be implemented using computer hardware in combination with software routine(s) written in a computer language (for example, Java, HTML, XML, PHP, Python, ActionScript, JavaScript, Ruby, Prolog, SQL, VBScript, Visual Basic, Perl, C, C++, Objective-C, Rust, and/or any other computer language). Additionally, it may be possible to implement operations using physical hardware that incorporates discrete or programmable analog, digital, and/or quantum hardware. Examples of programmable hardware include: computers, microcontrollers, microprocessors, application-specific integrated circuits (ASICs), field programmable gate arrays (FPGAs), and complex programmable logic devices (CPLDs). Computers, microcontrollers, and microprocessors may be programmed using languages such as assembly, C, C++, and/or any other language. FPGAs, ASICs, and CPLDs are often programmed using hardware description languages (HDL) such as VHSIC hardware description language (VHDL) or Verilog that configure connections between internal hardware operations with lesser functionality on a programmable device. Finally, it needs to be emphasized that the above-mentioned technologies may be used in combination to achieve the result of a functional operation. Automatic operations are performed automatically and do not require human intervention to complete once executed. Automatic as defined herein does not include any time limitations unless otherwise noted.

Some embodiments may utilize processing hardware. Processing hardware may include one or more processors, computer equipment, embedded systems, machines, and/or any other type of processing hardware. The processing hardware may be configured to execute instructions. The instructions may be stored on a machine-readable medium. According to some embodiments, the machine-readable medium (e.g., automated data medium) may comprise a medium that may be configured to store data in a machine-readable format that may be accessed by an automated sensing device. Examples of machine-readable media include: flash memory, memory cards, electrically erasable programmable read-only memory (EEPROM), solid state drives, optical disks, barcodes, magnetic ink characters, and/or any other type of machine-readable medium. Alternatively or additionally, the instructions may be encoded on an artificially generated propagated signal, e.g., a machine-generated electrical, optical, or electromagnetic signal, which is generated to encode information for transmission to a suitable receiver for execution by processing hardware. Moreover, while a machine-readable medium is not a propagated signal, a machine-readable medium may be a source or destination of instructions encoded in an artificially generated propagated signal.

While various embodiments have been described above, it should be understood that they have been presented by way of example, and not limitation. It should be apparent to persons skilled in the relevant art(s) that various changes in form and detail may be made therein without departing from the spirit and scope. In fact, after reading the above description, it should be apparent to one skilled in the relevant art(s) how to implement alternative embodiments. Thus, the present embodiments should not be limited by any of the above described example embodiments. In particular, it should be noted that, for example purposes, some systems for determining a condition of a projectile in flight data have been described as including a database and/or a user device. A person having ordinary skill in the art will recognize that the database may be collective based and comprise: portable equipment, broadcast equipment, virtual components, application(s) distributed over a broad combination of computing sources, part of a cloud, and/or any other collective based solution. Similarly, the user device may be a user based client, portable equipment, broadcast equipment, a virtual device, application(s) distributed over a broad combination of computing sources, part of a cloud, and/or any other user based solution. Additionally, it should be noted that, for example purposes, several of the various embodiments were described as programs. However, a person having ordinary skill in the art will recognize that many various languages and frameworks may be utilized to build and use embodiments of the present disclosure.

In this specification, various embodiments are disclosed. Limitations, features, and/or elements from the disclosed example embodiments may be combined to create further embodiments within the scope of the disclosure. Moreover, the scope includes any and all embodiments having equivalent elements, modifications, omissions, adaptations, or alterations based on the present disclosure. Further, aspects of the disclosed methods may be modified in any manner, including by reordering aspects, or inserting or deleting aspects.

In addition, it should be understood that any figures that highlight any functionality and/or advantages, are presented for example purposes only. It should be further understood that various figures (including component diagrams) shown and discussed above are for illustrative purposes only, and may not be drawn to scale. For example, the dimensions of some of the elements may be exaggerated relative to other elements for clarity. The disclosed architecture is sufficiently flexible and configurable, such that it may be utilized in ways other than that shown. For example, the blocks presented in any flowchart may be re-ordered or only optionally used in some embodiments. Furthermore, in certain circumstances, multitasking and/or parallel processing may be advantageous. Moreover, the separation of various system components in the embodiments described above should not be understood as requiring such separation in all embodiments. It should be further understood that the described program components may generally be integrated together in a single software module or packaged into multiple software modules.

Furthermore, many features presented above are described as being optional through the use of “may” or the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112. Claims that do not expressly include the phrase “means for” or “step for” are not to be interpreted under 35 U.S.C. 112.

What is claimed is:

1. An automated system comprising:
(a) at least one memory storing instructions; and
(b) at least one processor being configured to execute the instructions to perform operations, the operations comprising:
(i) automatically receiving an acoustic sensor signal from a single acoustic sensor, the single acoustic sensor physically connected to an unmanned aerial vehicle (UAV);
(ii) automatically determining that a projectile in flight is in a tumbling condition, the determining based on the acoustic sensor signal from the single acoustic sensor; and
(iii) automatically communicating a notification of the tumbling condition to a user of the system.

2. The system according to claim 1, wherein the projectile is structured to be spin stabilized in flight.

3. The system according to claim 1, wherein the single acoustic sensor comprises a microphone.

4. The system according to claim 1, the operations further comprising automatically comparing at least a portion of the acoustic sensor signal to stored sensor data.

5. The system according to claim 4, wherein:
(a) the operations further comprise automatically transforming at least the portion of the acoustic sensor signal to a frequency domain; and
(b) the comparing being performed in the frequency domain.

6. The system according to claim 4, wherein the determining is based on correlating one or more characteristics of the acoustic sensor signal to one or more characteristics of the stored sensor data, the one or more characteristics of the stored sensor data associated with a tumbling state.

7. The system according to claim 1, the operations further comprising automatically comparing at least a portion of the acoustic sensor signal to stored acoustic data, the stored acoustic data comprising acoustic sensor information captured by at least one other single acoustic sensor.

8. The system according to claim 7, wherein:
(a) the operations further comprise automatically transforming at least the portion of the acoustic sensor signal to a frequency domain; and
(b) the comparing being performed in the frequency domain.

9. The system according to claim 7, wherein the determining is based on correlating one or more characteristics of the acoustic sensor signal to one or more characteristics of the stored acoustic data, the one or more characteristics of the stored acoustic data associated with a tumbling state.

10. A method comprising:
(a) receiving an acoustic sensor signal from a single acoustic sensor, the single acoustic sensor physically connected to an unmanned aerial vehicle (UAV), the UAV being at a location between a final firing position (FFP) and a target;
(b) automatically determining that a projectile in flight is in a tumbling condition, the determining based on the acoustic sensor signal from the single acoustic sensor; and
(c) automatically communicating a notification of the tumbling condition to a user.

11. The method according to claim 10 further comprising automatically comparing at least a portion of the acoustic sensor signal to stored sensor data.

12. The method according to claim 11, wherein:
(a) the method further comprises automatically transforming at least the portion of the acoustic sensor signal to a frequency domain; and
(b) the comparing being performed in the frequency domain.

13. The method according to claim 11, wherein the determining is based on correlating one or more characteristics of the acoustic sensor signal to one or more characteristics of the stored sensor data, the one or more characteristics of the stored sensor data associated with a tumbling state.

14. The method according to claim 10 further comprising automatically comparing at least a portion of the acoustic sensor signal to stored acoustic data, the stored acoustic data comprising acoustic sensor information captured by at least one other single acoustic sensor.

15. The method according to claim 14, wherein:
(a) the method further comprises automatically transforming at least the portion of the acoustic sensor signal to a frequency domain; and
(b) the comparing being performed in the frequency domain.

16. The method according to claim 14, wherein the determining is based on correlating one or more characteristics of the acoustic sensor signal to one or more characteristics of the stored acoustic data, the one or more characteristics of the stored acoustic data associated with a tumbling state.

17. An unmanned aerial vehicle (UAV) comprising:
(a) a single acoustic sensor;
(b) at least one memory storing instructions; and
(c) at least one processor being configured to execute the instructions to perform operations, the operations comprising:
(i) automatically receiving an acoustic sensor signal from the single acoustic sensor;
(ii) automatically determining that a projectile in flight is in a tumbling condition, the determining based on the acoustic sensor signal from the single acoustic sensor; and
(iii) automatically communicating a notification of the tumbling condition to a user of the UAV.

18. The UAV according to claim 17, the operations further comprising automatically comparing at least a portion of the acoustic sensor signal to stored sensor data.

19. The UAV according to claim 18, wherein:
(a) the operations further comprise automatically transforming at least the portion of the acoustic sensor signal to a frequency domain; and
(b) the comparing being performed in the frequency domain.

20. The UAV according to claim 18, wherein the determining is based on correlating one or more characteristics of the acoustic sensor signal to one or more characteristics of the stored sensor data, the one or more characteristics of the stored sensor data associated with a tumbling state.
